(19) United States
(12) Patent Application Publication
(10) Pub. No.: US 2007/0123243 A1
(43) Pub. Date: May 31, 2007

(54) Remote control

(75) Inventor: Akiko Suito, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 11/527,315

(22) Filed: Sep. 26, 2006

(30) Foreign Application Priority Data
Sep. 26, 2005 (JP) 2005-277590

(51) Int. Cl. H04M 3/00

(52) U.S. Cl. 455/419

(57) ABSTRACT

To realize remote control of a shared terminal that can be used in common by users, an information-providing terminal displays code information containing information that can identify the location of installation of the information-providing terminal. Remote-control terminals read the code information displayed on the information-providing terminal and transmit to the shared terminal authentication request information containing the code information that has been read. Based on the authentication request information transmitted from the remote-control terminals, the shared terminal transmits use screens to the remote-control terminals.

### TECHNICAL FIELD

The present invention relates to a remote control system, a remote control method, and a remote control program for controlling a shared terminal that users can use in common.

### BACKGROUND ART

In recent years, IT (Information Technology) equipment is being actively adopted for use in conferences held in offices or schools. As a result, the typical conference style is undergoing a transition from a mode in which a presenter explains the data materials used in the conference while using a projector to display the data materials to a mode in which the data materials are displayed on an electronic information board that can communicate with information equipment centering around a computer and in which the presenter gives explanations while manipulating screens on the board.

An electronic information board is a device for displaying a computer screen on a board that allows manipulation of the screen by means of an accessory marker or by fingers. More specifically, electronic information boards include one type in which a white-board electronic information board, projector, and computer are combined to project the computer screen onto the electronic board by way of the projector; and another type in which a plasma display electronic information board and a computer are combined to directly display the computer screen on the electronic information board. The computer can be connected to a network and can be remote-controlled.

A shared terminal such as an electronic information board that does not restrict users is typically installed in the meeting space or free space of an office or school and can often be freely used by anyone. As a result, when a service that is open only to specific users is offered on a shared terminal, there is a possibility that the service may be used by users who are not supposed to use the service, whereby the resources of the shared terminal may be used unnecessarily. Here, services that are offered on a shared terminal that does not restrict users are not limited to services that can be used by all users that are permitted to use the shared terminal, but also include services that can be used by specific users or by group members that are composed of a plurality of people. “Services” are here assumed to be applications for executing programs or tools for providing information.

JP-2003-233586A and JP-2003-110551A disclose methods wherein the services that can be accessed by each user are automatically selected by referring to identification information such as the user IDs of users, whereby access to services that are not to be used can be prevented.

When pointing out a displayed screen on an electronic information board to give an explanation, the presenter may often step in front of the electronic information board and thus obstruct the view of members of the audience.

In response to this problem, JP-1998-283103A discloses a method in which the presenter uses a remote-control terminal that can, from a location remote from the electronic information board, control the displayed screen of the electronic information board to cause an arrow or other indicator to be displayed on the displayed screen, thereby enabling the presenter to point out the displayed screen and continue explanation without moving in front of the display.

JP-2001-224055A discloses a method in which, based on location information of a mobile terminal, services are offered that are appropriate to that location.

In this case, when a shared terminal that includes an electronic information board is controlled by means of a remote-control terminal, the method of using the remote-control terminal is not limited to one mode, but rather, differs for each user when the shared terminal is used by a plurality of people.

For example, a case is considered in which a presenter uses an electronic information board that is installed in the conference room of an office to give a presentation to an audience. The presenter stands at a location close to the electronic information board and proceeds with the presentation while using a remote-control terminal to manipulate the electronic information board, for example, flipping through the pages of the presentation materials that are displayed on the electronic information board. Members of the audience are able to view the presentation materials at a location separated from the electronic information board and to display hand-out screens of the presentation materials on remote-control terminals to highlight question points.

In other words, a form can be considered in which the role of a remote-control terminal varies depending on the location at which a user operates the remote-control terminal. However, users may encounter problems in designating the mode of use (type of use) and users may accidentally select the wrong mode of use.

A scheme is therefore desired in which the users of a shared terminal can make use of remote-control terminals based on appropriate use content by merely holding the remote-control terminals at the location in which the shared terminal is being used and without having to pay attention to the mode of use of the remote-control terminals. This use content means information on how to use the terminal.

Although JP-2003-233586A and JP-2003-110551A disclose methods for restricting the service functions offered to each user based on user information, these methods have the drawback that users can only use the terminals in the same way regardless of the location. A further drawback is that, because use of a shared terminal by a plurality of people is not even considered, a single service is not capable of providing a plurality of modes of use.

Still further, when a compact terminal that is provided with an electronic information board or in a conference room is used as a remote-control terminal that can manipulate an electronic information board, one remote-control terminal is typically provided for one conference room or one electronic information board. As a result, when an electronic information board is being used in a conference attended by a plurality of people, the lending and borrowing of a single remote-control terminal among the plurality of users becomes inconvenient. Further, the existence of only one remote-control terminal means that a remote-control terminal cannot be obtained at physically different locations (such as when participating in a conference from a different room by way of a network). These problems can be alleviated by providing a plurality of remote-control terminals to enable smooth manipulation of the electronic information board when desired. However, when a plurality of people have the freedom to perform remote operation of an electronic information board at any time, the operation by these users may interfere with the presenter's operation of the electronic information board.

However, because a plurality of remote-control terminals are not typically provided for a shared terminal, a scheme is now sought in which devices such as the portable telephones that belong to each user can be utilized as remote-control terminals, or further, in which the ability to execute operations from a remote-control terminal is controlled according to necessity.

However, the method disclosed in JP-1998-283103A suffers from the drawback that the presence of a plurality of remote-control terminals prevents the appropriate determination of whether to permit execution or not.

The method disclosed in JP-2001-224055A has the problem that, because the same service is offered to a plurality of mobile terminals having the same location information, service is also offered to mobile terminals that are not supposed to receive the service. This method has the additional problem that, because the service offered to mobile terminals is a unidirectional service such as advertisements or announcements, control cannot be exercised from the mobile terminals.

### DISCLOSURE OF THE INVENTION

It is an object of the present invention to provide a remote control system, remote control method, and remote control program that allow remote control of a shared terminal that can be used in common by users, wherein this remote control varies according to the location at which a user uses the shared terminal.

In the present invention, code information is displayed on an information-providing terminal, wherein this code information contains information that allows identification of the location at which the information-providing terminal is established. The code information that is displayed on the information-providing terminal is read by a remote-control terminal. Authentication request information that contains code information that has been read by the remote-control terminal is transmitted from the remote-control terminal to the shared terminal. The authentication request information transmitted from the remote-control terminal is received by the shared terminal. Based on the authentication request information that has been received by the shared terminal, the use content of the remote-control terminal is searched, and based on the use content that has been searched, use screens that show an information for the remote control of the shared terminal are transmitted from the shared terminal to the remote-control terminal. The use screens that have been transmitted from the shared terminal are received and displayed by the remote-control terminal.

In this way, use content that differs for each user is searched based on the information of a user who is holding a remote-control terminal for effecting remote control of a shared terminal, and use screens based on this use content are then transmitted from the shared terminal to the remote-control terminal. The user then effects remote control of the shared terminal in accordance with the use screens that are received and displayed by the remote-control terminal and thus is able to realize remote control of the shared terminal by methods that differ according to the location at which the user uses the remote-control terminal.

The above and other objects, features, and advantages of the present invention will become apparent from the following description with reference to the accompanying drawings which illustrate an example of the present invention.

### BRIEF DESCRIPTION OF THE DRAWINGS

FIG. 1 shows the first embodiment of the remote control system of the present invention;

FIG. 2 is a flow chart for explaining the remote control method by which the lecturer of a seminar controls a shared terminal in the remote control system shown in FIG. 1;

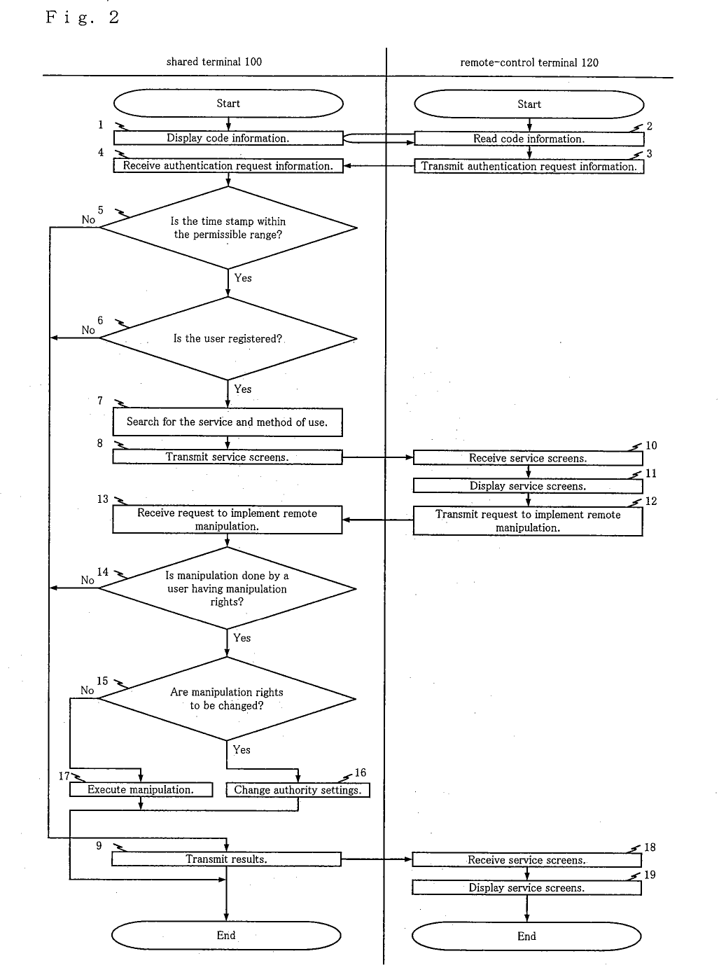

FIG. 3(a) shows an example of the configuration of user information that is stored in, for example, a hard disk for use by the remote control terminal authentication unit shown in FIG. 1 in the first embodiment;

FIG. 3(b) shows an example of the configuration of service information that is stored in, for example, a hard disk for use by the service control unit shown in FIG. 1 in the first embodiment;

FIG. 3(c) shows an example of the configuration of operation information that is stored in, for example, a hard disk for use by the service control unit shown in FIG. 1 in the first embodiment;

FIG. 4 is a flow chart for explaining the remote control method by which a member of the audience of a seminar controls a shared terminal in the remote control system shown in FIG. 1;

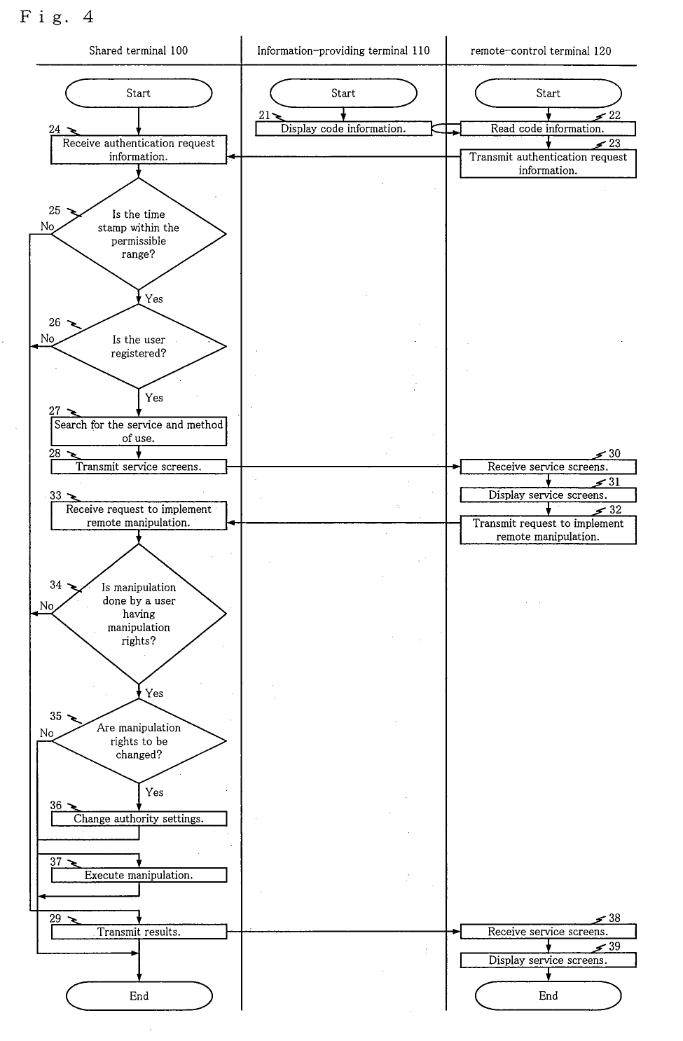

FIG. 5 shows the second embodiment of the remote control system of the present invention;

FIG. 6 is a flow chart for explaining the remote control method by which a remote control terminal is used to control a shared terminal in the remote control system shown in FIG. 5;

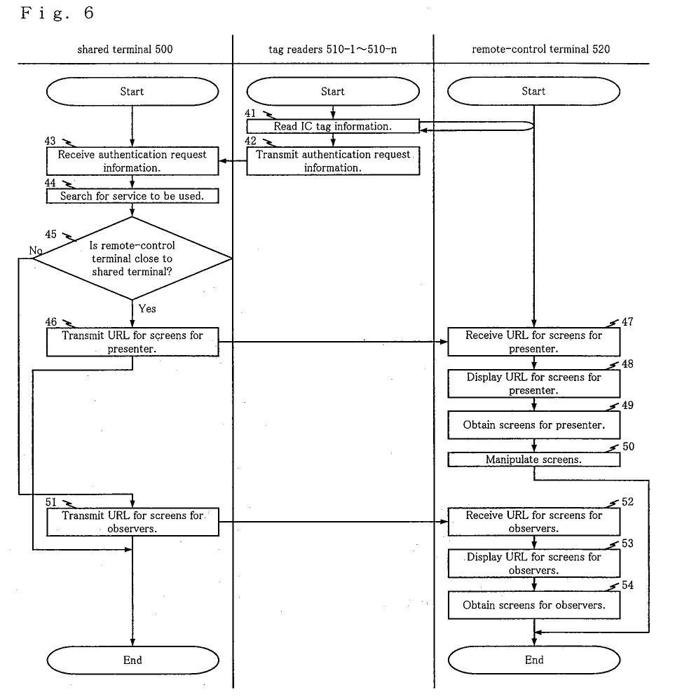

FIG. 7 shows an example of the database format of operation information that is stored in a shared terminal in the second embodiment;

FIG. 8 shows the third embodiment of the remote control system of the present invention; and

FIG. 9 is a flow chart for explaining the remote control method in a shared terminal of the remote control system shown in FIG. 8.

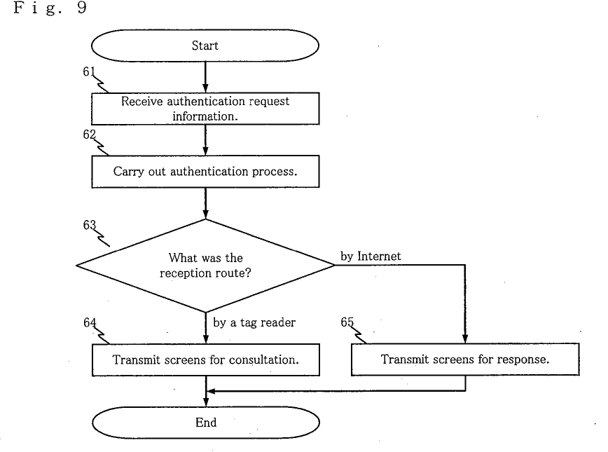

### BEST MODE FOR CARRYING OUT THE INVENTION

### First Embodiment

As the first embodiment, explanation first regards an example of a form for using seminar equipment (a personal computer), which is the shared terminal, to hold a seminar.

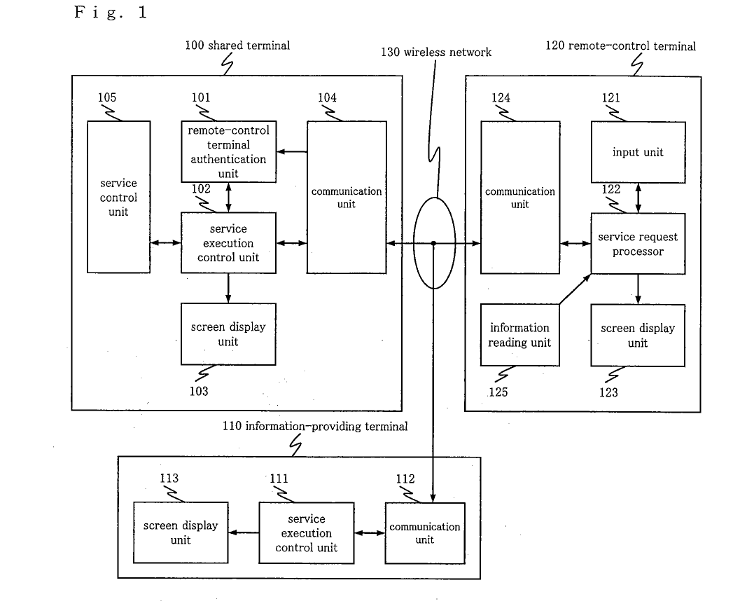

Referring to FIG. 1, the first embodiment of a remote control system is shown that is composed of: shared terminal 100, information-providing terminal 110 connected to shared terminal 100 by way of a wireless network 130, and remote-control terminal 120 connected to shared terminal 100 by way of wireless network 130. Shared terminal 100 is further composed of remote-control terminal authentication unit 101, service execution control unit 102, screen display unit 103, communication unit 104, and service control unit 105; Remote-control terminal authentication unit 101 authenticates remote-control terminal 120. Service control unit 105 controls the services that are supplied to remote-control terminal 120. Service execution control unit 102 controls the execution of services depending on remote-control terminal 120. Screen display unit 103 displays the state of the executed services on a screen. Communication unit 104 communicates with information-providing terminal 110 and remote-control terminal 120 by way of wireless network 130. Information-providing terminal 110 is further composed of service execution control unit 111, communication unit 112, and screen display unit 113. Service execution control unit 111 generates the code information of information-providing terminal 110. Screen display unit 113 displays the code information that has been generated by service execution control unit 111. Communication unit 112 communicates with shared terminal 100 and remote-control terminal 120 by way of wireless network 130. Details regarding this code information will be described later. Remote-control terminal 120 is composed of input unit 121, service request processor 122, screen display unit 123, communication unit 124, and information reading unit 125. Information reading unit 125 reads the information displayed on screen display unit 103 or screen display unit 113. Input unit 121 receives as input content by which the user that is holding remote-control terminal 120 manipulates remote-control terminal 120. Service request processor 122 issues a request for service to shared terminal 100 and receives the result. Screen display unit 123 displays the result that has been received by service request processor 122. Communication unit 124 communicates with shared terminal 100 and information-providing terminal 110 by way of wireless network 130.

Shared terminal 100 is assumed to be installed on the podium of a seminar site. Information-providing terminal 110 is assumed to be installed near the entrance to the seminar site. In addition, remote-control terminals 120 are assumed to be portable telephones possessed by the lecturer and participants of a seminar. Screen display unit 103 may be connected by a display cable to shared terminal 100. Similarly, screen display unit 113 may be a device separate from information-providing terminal 110 that is connected by means of a display cable. Remote-control terminal authentication unit 101 records user information that includes the user IDs of users who can effect remote control of shared terminal 100 on a recording medium such as a disk (not shown) or memory (not shown) provided in shared terminal 100. Service control unit 105 records information of services that shared terminal 100 can offer and further, records the role of each terminal that operates in the system, service content, and authority information for manipulating shared terminal 100 in association with each other as operation information on a recording medium such as a disk (not shown) or memory (not shown) that is provided in shared terminal 100. Input unit 121 may be the physical buttons for manipulation that are provided on the portable telephones, or may be virtual buttons displayed on screen display unit 123. Screen display unit 123 is assumed to be a compact liquid crystal display provided on remote-control terminal 120. Radio access points (not shown) are interposed in wireless network 130, and when information-providing terminal 110 and remote-control terminal 120 transmit data to and receive data from shared terminal 100, the data are transmitted and received by way of these access points. It is further assumed that each of the programs and databases that operate in shared terminal 100, information-providing terminal 110, and remote-control terminal 120 are stored on hard disks (not shown) as a recording medium that are physically provided in each of these terminals, and are each transferred as necessary to memories (not shown) and executed by CPUs (not shown) that are provided for each of these terminals. Information reading unit 125 may further be a camera that belongs to the portable telephones.

Explanation next regards a remote control method in the remote control system configured as described above.

Explanation first regards the remote control method by which a lecturer of a seminar controls shared terminal 100.

When shared terminal 100 is activated, code information is displayed on screen display unit 103 of shared terminal 100 in Step 1. This code information is two-dimensional code that contains an identifier of shared terminal 100 (terminal ID) for identifying the location at which shared terminal 100 is installed. This code information is not limited to two-dimensional code as long as the code is of a format having a data structure that can contain an identifier for identifying shared terminal 100. More specifically, the URL for accessing the Web server (not shown) that is activated by shared terminal 100 is included in the two-dimensional code. Accessing this URL causes processing to start in service execution control unit 102. A time stamp is included in this code information, and this time stamp is periodically updated. The terminal ID of shared terminal 100 is here assumed to be “20000001.”

The lecturer of the seminar manipulates input unit 121 of remote-control terminal 120 and the code information displayed on screen display unit 103 is read by information reading unit 125 in Step 2, whereupon authentication request information that contains verification information for verifying the user of remote-control terminal 120 to enable use of shared terminal 100 is transmitted by service request processor 122 of remote-control terminal 120 to shared terminal 100 by way of communication unit 124 in Step 3. This authentication request information includes the identifier of shared terminal 100 that is included in the code information, a time stamp, and verification information of remote-control terminal 120. The verification information is data generated in remote-control terminal authentication unit 101 that contain the user ID and that have been acquired in advance by remote-control terminal 120. The verification information may be information generated by another means of shared terminal 100, or may be issued by a device for issuing other verification information.

When the authentication request information has been transmitted from remote-control terminal 120 to shared terminal 100 by way of wireless network 130 in Step 2, the transmitted authentication request information is received in remote-control terminal authentication unit 101 by way of communication unit 104 of shared terminal 100 in Step 4.

Remote-control terminal authentication unit 101 next determines whether the time difference between the current time and the time stamp that is included in the received authentication request information is within the range of the permissible authentication time interval in Step 5. Here, the permissible authentication time interval is numerical value data that have been set in advance in remote control terminal authentication unit 101. If the permissible authentication time interval is, for example, “60 minutes,” the authentication request is accepted provided that the time difference between the current time and the value of the time stamp is within 60 minutes, but the authentication request is not accepted if the time difference exceeds 60 minutes.

If the time difference between the current time and the value of the time stamp is determined to be within the range of the permissible authentication time interval, the user ID is extracted from the verification information contained in the received authentication request information. Remote-control terminal authentication unit 101 compares the extracted user ID with the user ID contained in user information that has been recorded in advance in the recording medium in shared terminal 100 in Step 6.

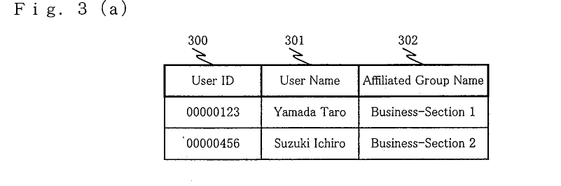

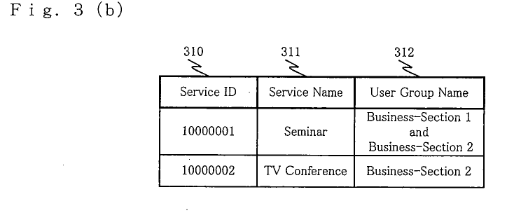

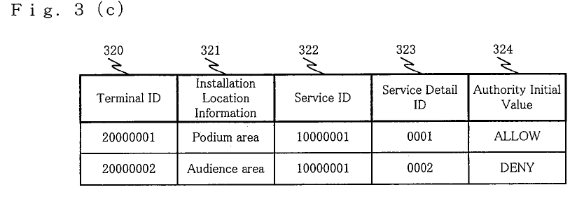

The information shown in each of FIGS. 3(a), 3(b), and 3(c) must be stored in advance in, for example, the hard disk of shared terminal 100 by a system operator.

Referring to FIG. 3(a), user information is shown in which user ID 300, user name 301, and affiliated group name 302 are stored in association with each other. User ID 300 is ID for identifying the user. User name 301 is the name of the user. Affiliated group name 302 is the name of the group to which the user belongs.

Referring to FIG. 3(b), service information is shown in which service ID 310, service name 311, and user group name 312 are stored in association with each other. Service ID 310 is the ID for identifying the service. Service name 311 is the service name of that service. User group name 312 is the group name that indicates one or more affiliated groups that can use that service.

Referring to FIG. 3(c), operation information is shown in which terminal ID 320, installation location information 321, service ID 322, service detail ID 323, and authority initial value 324 are stored in association with each other. Terminal ID 320 is ID for identifying shared terminal 100 and terminals that are linked with shared terminal 100. Installation location information 321 is information showing the location at which the terminal is installed. Service ID 322 is an ID for identifying service that can be used when that terminal is installed in the designated installation location. Service detail ID 323 is detailed information of the service. Authority initial value 324 is the initial value of the authority to manipulate that is in the use content that has been assigned to service detail ID 323. In this case, “ALLOW” of authority initial value 324 indicates the authority to manipulate, and “DENY” indicates a lack of authority to manipulate. The input data of authority initial value 324 may designate a condition formula to allow authority to be set for each user ID 300 or for each affiliation group name 302.

Remote-control terminal authentication unit 101 performs a search to discover whether a user ID identical to the user ID that has been extracted from the verification information exists in user ID 300 shown in FIG. 3(a). If the same user ID exists, service control unit 105 performs a search to discover whether a group name identical to affiliated group name 302 that is associated with user ID 300 exists in user group name 312.

As an example, an authentication request is carried out in which user ID 300 is “00000123” and user name 301 is “Yamada Taro.” As shown in FIG. 3(a), affiliated group 302 of “Yamada Taro” is seen to be “Business Section 1.” A search is then performed to determine whether this affiliated group name “Business Section 1” is in user group name 312 of the service information shown in FIG. 3(b). If this affiliated group name “Business Section 1” is in user group name 312 of the service information shown in FIG. 3(b), service name 311 and service ID 310 that correspond to that user group name 312 are acquired. In this case, service name 311 “seminar” and service ID 310 “10000001” are acquired. A search is further performed to determine whether the set of acquired service ID “10000001” and terminal ID “20000001,” which is the identifier of shared terminal 100 that is included in the authentication request information, are in service ID 322 and terminal ID 320 of the operation information shown in FIG. 3(c). If the set of service ID “10000001” and terminal ID “20000001” is in service ID 322 and terminal ID 320 of the operation information shown in FIG. 3(c), service detail ID 323 that corresponds to this set is acquired. In this case, service detail information 323 “0001” is acquired and authority initial value 324 that corresponds to this acquired service detail ID is “ALLOW,” whereby it is recognized that this authority is held. The search of use content is carried out in this way in Step 7.

When service detail ID 323 has been acquired by service control unit 105, service use screens are generated by service execution control unit 102 based on service detail ID 323 that has been acquired. The service use screens generated by service execution control unit 102 are transmitted by way of wireless network 130 from communication unit 104 to remote-control terminal 120 in Step 8. The service use screens that are here generated have information that is shown on use screens and are use screen data that take into consideration the manipulation authority that depends on the use content of the service. More specifically, screens that contain service manipulation tools are generated for users having the authority to manipulate shared terminal 100. On the other hand, screens that do not contain service manipulation tools are generated for users that lack the authority to manipulate shared terminal 100.

At this time, service execution control unit 102 supplies shared screens of service as output to screen display unit 103 based on service detail ID 323, and these shared screens are displayed on screen display unit 103. Service execution control unit 102 further holds as authority information the user IDs of users who are using the service and their corresponding manipulation authority until this service ends. More specifically, service execution control unit 102 updates and holds the values of authority initial values 324 of the operation information shown in FIG. 3(c).

On the other hand, when the time difference between the current time and the time stamp value that is included in the authentication request information is determined to be outside the range of permissible authentication time in Step 5, service execution control unit 102 generates an authentication result screen indicating that use is not permitted and transmits this screen from communication unit 104 to remote-control terminal 120 by way of wireless network 130 in Step 9.

If it is determined that a user ID identical to the user ID extracted from the verification information in Step 6 does not exist in user ID 300 shown in FIG. 3(a), service execution control unit 102 generates an authentication result screen indicating that use is not permitted. The generated screen is then transmitted from communication unit 104 to remote-control terminal 120 by way of wireless network 130 in Step 9.

The screen that is transmitted to remote-control terminal 120 in Step 9 may also be displayed as an authentication process result on screen display unit 103.

When a plurality of services that can be used by a user are acquired in Step 7, a list of these services may be generated and the generated list then may be transmitted to remote-control terminal 120. At such times, the list may be displayed on screen display unit 103.

In Step 8, when a service use screen is transmitted from shared terminal 100 to remote-control terminal 120 by way of wireless network 130, the service use screen is received in communication unit 124 of remote-control terminal 120 in Step 10, and the received use screen is screen-displayed on screen display unit 123 in Step 11. For example, when the data of the use screen are HTML content, an application having browser functions is used to display the application screen. In addition, a user interface for manipulating shared terminal 100 is included in the application screen, and the user, by manipulating input unit 121, realizes remote manipulation of shared terminal 100. The means for effecting manipulation may also be keys such as the numerical buttons of remote-control terminal 120.

The use screen is displayed on screen display unit 123 of remote-control terminal 120, and the lecturer of the seminar, in order to realize remote manipulation of shared terminal 100, enters shared terminal manipulation request information that includes manipulation information, a service ID, and a user ID into the application screen that is displayed on screen display unit 120. The entered shared terminal manipulation request information is transmitted from service request processor 122 to shared terminal 100 by way of communication unit 124 in Step 12. In this case, the service ID and user ID are assumed to be included in the use screen that is transmitted from shared terminal 100 and received in remote-control terminal 120.

The shared terminal manipulation request information that has been transmitted from remote-control terminal 120 passes by way of wireless network 130 and is received in shared terminal 100 in Step 13. The shared terminal manipulation request information that is received in shared terminal 100 is received in service execution control unit 103 by way of communication unit 104.

Then, using the service ID and user ID in the shared terminal manipulation request information that has been received in service execution control unit 103 as a search key, a search is performed for the held authority information to determine whether that remote-control terminal 120 has the authority to permit use in Step 14.

If the service ID and user ID in the received shared terminal manipulation request information are in the held authority information, it is next determined whether the manipulation information contained in the shared terminal manipulation request information is information for changing the manipulation rights or information for manipulating screen display unit 103 of shared terminal 100 in Step 15. A user interface that allows change of the manipulation rights can be offered on screen display unit 123 of remote-control terminal 120, and the user can use this user interface to transfer manipulation rights to other users or to release manipulation rights for all users other than himself or herself. The user interface for changing manipulation rights is displayed on screen display unit 123 of remote-control terminal 120 that is used by a user having manipulation rights. This user interface is not displayed on screen display unit 123 of remote-control terminal 120 used by a user that lacks manipulation rights. When it is determined that the manipulation information is information for changing manipulation rights, service execution control unit 102 changes the manipulation rights of the manipulation information based on the service ID, user ID, and manipulation information contained in the shared terminal manipulation request information and updates the data of the authority information in Step 16.

When it is determined that the manipulation information is information for manipulating screen display unit 103 of shared terminal 100, service execution control unit 102 manipulates the screen displayed on screen display unit 103 of shared terminal 100 based on the manipulation information contained in the shared terminal manipulation request information. More specifically, execution commands of the service application are contained in the manipulation information, and service execution control unit 102 executes these commands in Step 17.

In Step 14, if the service ID and user ID in the received shared terminal manipulation request information are not in the held authority information, service execution control unit 102 determines that shared terminal manipulation request information has been transmitted from a user that lacks manipulation rights for the service that is being executed. An authentication result screen indicating that use is not permitted is then generated and transmitted from communication unit 104 to remote-control terminal 120 by way of wireless network 130 in Step 9.

The authentication result screen that is transmitted from shared terminal 100 is received in communication unit 124 of remote-control terminal 120 in Step 18 and displayed on screen display unit 123 in Step 19.

Explanation next regards the remote control method by which an attendee of a seminar can control shared terminal 100.

First, when information-providing terminal 110 is activated, code information is displayed on screen display unit 113 of information-providing terminal 110 in Step 21. This code information is two-dimensional code generated in service execution control unit 111 and contains the identifier of information-providing terminal 110 (terminal ID) for identifying the location of installed information-providing terminal 110. As long as the code is of a format having a data structure that can contain an identifier for identifying information-providing terminal 110, this code is not limited to two-dimensional code. More specifically, a URL for accessing a Web server (not shown) that is activated by shared terminal 100 is contained in the two-dimensional code. Accessing this URL causes the start of processing in service execution control unit 102. A time stamp is included in this code information, and this time stamp is periodically updated. In addition, the terminal ID of information-providing terminal 110 is assumed to be “20000002.”

Input unit 121 of remote-control terminal 120 is manipulated by a seminar attendee, and information reading unit 125 is used to read the code information that is displayed on screen display unit 113 in Step 22. Service request processor 122 of remote-control terminal 120 then transmits to shared terminal 100 by way of communication unit 124 in Step 23 authentication request information that contains verification information for verifying whether the user of remote-control terminal 120 is allowed to use shared terminal 100 for use of shared terminal 100. This authentication request information contains the identifier of information-providing terminal 110 that is contained in the code information, a time stamp, and verification information of remote-control terminal 120. The verification information is data that have been generated in remote-control terminal authentication unit 101 and that include a user ID, and this verification information is acquired in advance by remote-control terminal 120. Alternatively, the verification information may be generated by selecting another means of shared terminal 100, or may be issued by another device for issuing verification information.

In Step 22, authentication request information is transmitted from remote-control terminal 120 to shared terminal 100 by way of wireless network 130, and the transmitted authentication request information is received in remote-control terminal authentication unit 101 by way of communication unit 104 in Step 24.

Remote-control terminal authentication unit 101 next determines whether the time difference between the current time and the value of the time stamp that is contained in the received authentication request information is within the range of the permissible authentication time interval in Step 25. In this case, the permissible authentication time interval is numerical data that have been set in advance in remote-control terminal authentication unit 101. If, for example, the permissible authentication time interval is set to “60 minutes,” the authentication request is accepted provided that the time difference between the current time and the time stamp value is within 60 minutes, but the authentication request is not accepted if the time difference exceeds 60 minutes.

If the time difference between the time stamp value and the current time is determined to be within the range of the permissible authentication time interval, the user ID is extracted from the verification information contained within the received authentication request information. The extracted user ID is compared with the user ID contained within the user information that has been recorded in advance in the recording medium in shared terminal 100 by remote-control terminal authentication unit 101 in Step 26.

When the extracted user ID and user ID contained in the user information that has been recorded in advance in the recording medium in shared terminal 100 are compared and a match occurs, the user is determined to be a registered user, and a search is performed for the service and use content in Step 27. The search method is similar to the case for the seminar lecturer described previously in Step 7.

Then, as in Step 8, a service use screen is generated based on the service and use content that have been searched. The generated service use screen is transmitted from communication unit 104 to remote-control terminal 120 by way of wireless network 130 in Step 28. The service use screen that is generated in this case is use screen data that take into consideration the manipulation authority that depends on the use content of that service. More specifically, a screen containing manipulation tools of the service is generated for users having the authority to manipulate shared terminal 100, and a screen that does not contain manipulation tools of the service is generated for users that lack the authority to manipulate shared terminal 100.

At this time, based on service detail ID 323, service execution control unit 102 supplies shared screens of the service as output to screen display unit 103, and these shared screens are displayed on screen display unit 103. Service execution control unit 102 further holds the user IDs of the users that are using the service and their manipulation authority in association with each other as authority information until the service ends.

On the other hand, if the time difference between the current time and the value of the time stamp that is contained in the authentication request information is determined to be outside the range of the permissible authentication time interval in Step 25, service execution control unit 102 generates an authentication result screen indicating that use cannot be permitted and transmits this screen from communication unit 104 to remote-control terminal 120 by way of wireless network 130 in Step 29.

Further, when it is determined based on the user ID that is extracted from the verification information that the user is not registered in Step 26, service execution control unit 102 generates an authentication result screen indicating that use cannot be permitted. The generated screen is then transmitted from communication unit 104 to remote-control terminal 120 by way of wireless network 130 in Step 29.

The screen transmitted from remote-control terminal 120 in Step 29 may also be displayed as authentication process results on screen display unit 103.

When a plurality of services that can be used by a user is acquired in Step 27, a list of these services may be generated and this generated list then transmitted to remote-control terminal 120. At this time, the list may be displayed on screen display unit 103.

When a service use screen is transmitted from shared terminal 100 to remote-control terminal 120 by way of wireless network 130 in Step 28, this service use screen is received in communication unit 124 of remote-control terminal 120 in Step 30. The received use screen is screen-displayed on screen display unit 123 in Step 31. For example, when the use screen data are HTML content, an application having browser functions is used to display the application screen. This application screen includes a user interface for manipulating shared terminal 100, and the user thus realizes remote manipulation of shared terminal 100 by manipulating input unit 121. The means for realizing this manipulation may be keys such as the numerical buttons of remote-control terminal 120.

A use screen is displayed on screen display unit 123 of remote-control terminal 120, and in order for the attendee of the seminar to carry out remote manipulation of shared terminal 100, shared terminal manipulation request information that contains manipulation information, service ID, and the user ID is applied as input in the application screen displayed on screen display unit 120, whereupon the applied shared terminal manipulation request information is transmitted from service request processor 122 to shared terminal 100 by way of communication unit 124 in Step 32. In this case, it is assumed that the service ID and user ID are included in the use screen that is transmitted from shared terminal 100 and received in remote-control terminal 120.

The shared terminal manipulation request information that has been transmitted from remote-control terminal 120 is received in shared terminal 100 by way of wireless network 130 in Step 33. The shared terminal manipulation request information that has been received in shared terminal 100 is received in service execution control unit 103 by way of communication unit 104.

Then, using the service ID and user ID in the shared terminal manipulation request information that has been received in service execution control unit 102 as the search key, a search is performed of the held authority information to determine whether remote-control terminal 120 has authority for use in Step 34.

If the service ID and user ID in the received shared terminal manipulation request information are in the authority information that is held, it is next determined whether the manipulation information that is contained in the shared terminal manipulation request information is information for changing the manipulation rights or information for manipulating screen display unit 103 of shared terminal 100 in Step 35. A user interface that allows changes of the manipulation rights is provided on screen display unit 123 of remote-control terminal 120, and the user can use this user interface to transfer manipulation rights to other users or to release the manipulation rights of all users other than himself or herself. The user interface for changing manipulation rights is displayed on screen display units 123 of remote-control terminals 120 that are used by users having manipulation rights. The user interface is not displayed on screen display units 123 of remote-control terminals 120 used by users who lack manipulation rights. When it is determined that the manipulation information is information for changing manipulation rights, service execution control unit 102 changes the manipulation rights of the manipulation information based on the manipulation information, service ID, and user ID contained in the shared terminal manipulation request information, and the data of the authority information is updated in Step 36.

On the other hand, when it is determined that the manipulation information is information for manipulating screen display unit 103 of shared terminal 100, service execution control unit 102 manipulates the screens that are displayed on screen display unit 103 of shared terminal 100 based on the manipulation information that is contained in the shared terminal manipulation request information. More specifically, the execution commands of a service application are included in the manipulation information, and these commands are executed by service execution control unit 102 in Step 37. However, when the seminar attendee is only allowed to observe, the screen displayed on screen display unit 103 cannot be manipulated.

If the service ID and user ID in the received shared terminal manipulation request information are not present in the held authority information in Step 34, service execution control unit 102 determines that the shared terminal manipulation request information has been transmitted from a user that lacks manipulation rights for the service being executed. An authentication result screen indicating that use is not permitted is then generated and transmitted from communication unit 104 to remote-control terminal 120 by way of wireless network 130 in Step 29.

The authentication result screen that has been transmitted from shared terminal 100 is then received in communication unit 124 of remote-control terminal 120 in Step 38 and displayed on screen display unit 123 in Step 39.

The exchange of data between shared terminal 100 and remote-control terminals 120 that are held by attendees may be realized through information-providing terminal 110.

In addition, a limit may be placed on the number of remote-control terminals 120 that can exercise remote control over shared terminal 100.

The time interval during which shared terminal 100 is remote-controlled by remote-control terminal 120 may be stored in shared terminal 100. In other words, the time interval from carrying out authentication of remote-control terminal 120 until operation of the remote control ends may be stored in shared terminal 100.

In the above-described first embodiment, explanation regarded a case in which shared terminal 100 and information-providing terminal 110 were installed in different locations. Users each used respective terminals installed in different locations to request authentication, whereby use screens appropriate to remote-control terminal 120 of each user could be displayed and remote-control terminals 120 could be utilized by different use modes. More specifically, by requesting authentication on shared terminal 100 on the podium, the seminar lecturer is able to implement remote manipulation of a service that is executed by shared terminal 100 while viewing a screen for the presenter that includes an interface that allows manipulation of seminar materials.

On the other hand, by requesting authentication on information-providing terminal 110 that is installed at the entrance of the seminar site, a plurality of attendees utilize use screens that allow individual viewing of the seminar materials.

When the lecturer finishes the lecture on the seminar materials and responds to questions, the lecturer is able to manipulate an interface for temporarily releasing manipulation rights that is displayed on remote-control terminal 120 that is held by the lecturer to enable manipulation of seminar materials by remote-control terminals 120 that are held by attendees. As an effect that is further obtained, the provision of a time stamp in the code information can prevent persons who have used the service hours in advance from improperly using the service.

### Second Embodiment

As the second embodiment, a case is described in which TV conference equipment (a personal computer), which is the shared terminal, is used to hold a TV conference.

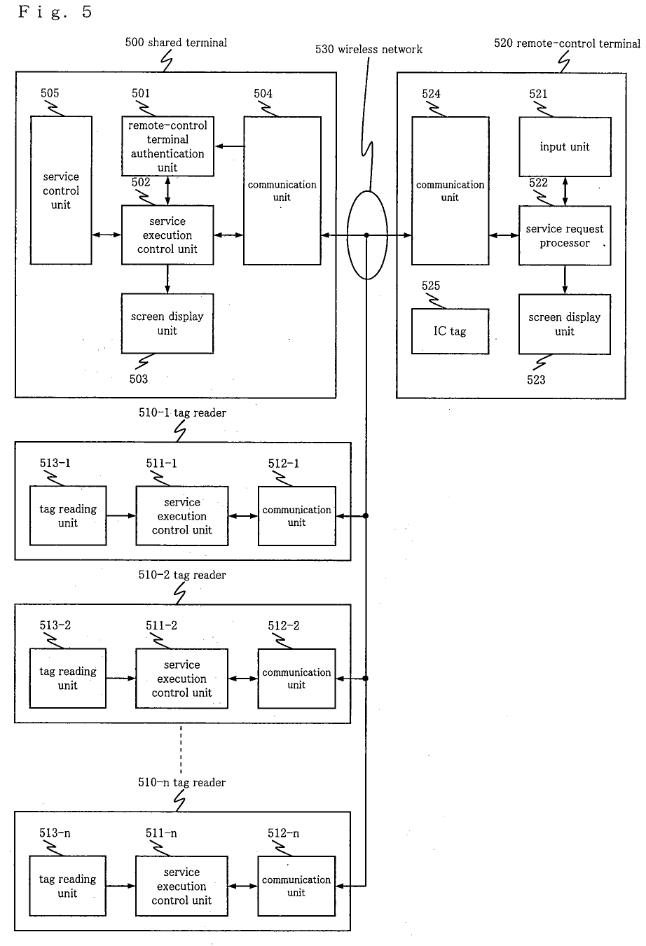

Referring to FIG. 5, the second embodiment of a remote control system is shown that is composed of: shared terminal 500; tag readers 510-1-510-n, which are readers; and remote-control terminal 520; each of these components being connected by way of wireless network 530. Shared terminal 500 is further composed of: remote-control terminal authentication unit 501; service execution control unit 502; screen display unit 503; communication unit 504; and service control unit 505. Remote-control terminal authentication unit 501 performs authentication of remote-control terminals 520. Service control unit 505 controls the services that are supplied to remote-control terminals 520. Service execution control unit 502 controls the execution of services in accordance with remote-control terminal 520. Screen display unit 503 displays screens of the state of the services that are being executed. Communication unit 504 communicates with tag readers 510-1-510-n and remote-control terminals 520 by way of wireless network 530. In addition, tag readers 510-1-510-n are each composed of: service execution control units 511-1-511-n; communication units 512-1-512-n; and tag reading units 513-1-513-n, respectively. Communication units 512-1-512-n connect the radio waves of wireless network 530 and tag readers 510-1-510-n. Tag reading units 513-1-513-n read the information of IC tags. Service execution control units 511-1-511-n transmit authentication request information to shared terminal 500 based on the IC tag information that has been read by tag reading units 513-1-513-n. Each remote-control terminal 520 is composed of: input unit 521; service request processor 522, screen display unit 523, communication unit 524, and IC tag 525. Input unit 521 receives as input the content by which the user who is holding remote-control terminal 520 manipulates remote-control terminal 520. Service request processor 522 issues requests for service to shared terminal 500 and accepts the results of these requests. Screen display unit 523 displays the results that have been accepted in service request processor 522. Communication unit 524 communicates with shared terminal 500 and tag readers 510-1-510-n by way of wireless network 530. Individual identification information of remote-control terminals 520 is written in advance into IC tags 525 as IC tag information. In this case, the individual identification information is destination information such as users' IDs or e-mail addresses for identifying remote-control terminals 520.

Shared terminal 500 is installed on the front wall as seen from the seats in the conference room. Remote-control terminals 520 are assumed to be portable terminals belonging to participants in the TV conference. Tag readers 510-1-510-n are installed in locations separated by spaces of several meters within the conference room, tag reader 510-1 being installed at the location closest to shared terminal 500. In addition, the distance between shared terminal 500 and the locations installed tag readers 510-1-510-n is set in advance in shared terminal 500. Screen display unit 503 may be connected by a display cable to shared terminal 500. Remote-control terminal authentication unit 501 records user information that includes the user IDs of users that can effect remote control of shared terminal 500 on a recording medium such as a disk (not shown) or memory (not shown) provided in shared terminal 500. Service control unit 505 records information of services that shared terminal 500 can offer and further, records the role of each terminal that operates in the system, service content, and authority information for manipulating shared terminal 500 in association with each other as operation information on a recording medium such as a disk (not shown) or memory (not shown) that is provided in shared terminal 500. Input unit 521 may be the physical buttons for manipulation that are provided on the portable telephones, or may be virtual buttons displayed on screen display unit 523. Screen display unit 523 is assumed to be a compact liquid crystal display equipped on remote-control terminal 520. Radio access points (not shown) are interposed in wireless network 530, and when tag readers 510-1-510-n and remote-control terminal 520 transmit and receive data with shared terminal 500, the data pass by way of these access points. It is further assumed that each of the programs and databases that operate in shared terminal 500, tag readers 510-1-510-n, and remote-control terminal 520 are stored on hard disks (not shown) as a recording medium that are physically provided in each of these terminals, and are each transferred as necessary to memories (not shown) and executed by CPUs (not shown) that are provided in each of these terminals. In addition, IC tags 525 use active RFID (Radio Frequency Identification) that issues weak radio waves. When IC tags 525 are applied to a wireless network, IC tags 525 can connect directly to wireless network 530 and exchange data with communication units 512-1-512-n of tag readers 510-1-510-n.

The operation of each of the constituent elements of the above-described shared terminal 500 is substantially identical to the operation of each of the constituent elements of shared terminal 100 in the first embodiment of the present invention. The point of difference with the operation of shared terminal 100 in the first embodiment is the selection of the use content of service based on the “location information” of each of installed tag readers 510-1-510-n without dealing with “code information.”

Explanation next regards the remote control method in the remote control system that is configured as described above.

As in the first embodiment, operation information for each service ID that is being executed is first stored in service execution control unit 502 of shared terminal 500, this operation information being composed of the service detail IDs, the user IDs currently in use, the manipulation authority of these users, the maximum connection number, and the number of completed connections. The “number of completed connections” is the total number of remote-control terminals 520 that are already using services. Control is implemented such that the “number of completed connections” does not exceed a “maximum connection number” that has been defined in the operation information. More specifically, when the movement of the location of a user who is holding remote-control terminal 520 that is already executing service causes a change in the use content of services that are offered to remote-control terminal 520, remote-control terminal 520 is set in a reserved state and the use content remains unchanged when the maximum connection number and number of completed connections are the same value. If remote-control terminal 520 that is in a reserved state satisfies execution conditions that are the same as those conditions the time of entering the reserved state when the number of completed connections falls below the maximum connection number, service execution control unit 502 transmits relevant use screens.

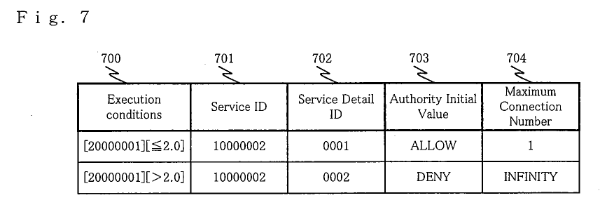

Referring to FIG. 7, operation information is shown that has been stored in service control unit 505, this operation information being execution conditions 700, service ID 701, service detail ID 702, authority initial value 703, and maximum connection number 704 that have been placed in association with each other in advance. Execution conditions 700 are conditions for executing services. Service ID 701 is identification information of services that can be offered to a user in a location that satisfies the execution conditions. Service detail ID 702 is detail information of the service. Authority initial value 703 is the initial value of the authority for manipulation in which use content is assigned that is indicated in service detail ID 702. Maximum connection number 704 is the maximum number of connections of terminals to which the use content indicated in service detail ID 702 can be applied.

In execution conditions 700, the terminal ID, which is the identification information of shared terminal 500, is stored enclosed within the first set of brackets ([ ]), and the distance (units: meters) from the relevant shared terminal 500 is stored enclosed within the second set of brackets.

When “[20000001] [≦2.0]” is stored as shown in FIG. 7, the conditions are “within 2.0 meters of terminal ID=20000001.” “ALLOW” of authority initial value 703 indicates the possession of manipulation authority, while “DENY” indicates the lack of manipulation authority. Maximum connection number 704 stores a numerical value or “INFINITY” (no limit).

The presenter that is holding the conference first takes remote-control terminal 520 that he or she possesses to the vicinity of shared terminal 500 that has been installed in the conference room, whereupon tag reading unit 513-1 of tag reader 510-1 that is installed close to shared terminal 500 reads the IC tag information that is written in IC tag 525 of remote-control terminal 520 that is held by the presenter in Step 41.

Service execution control unit 511-1 generates authentication request information based on the IC tag information that has been read by IC tag 513-1 and the tag reader identification information for identifying tag reader 510-1 that is stored in advance in tag reader 510-1. The generated authentication request information is then transmitted from communication unit 512-1 to shared terminal 500 by way of wireless network 530 in Step 42.

When the authentication request information that is transmitted from tag reader 510-1 is received in shared terminal 500 in Step 43, a search is performed for use content based on the user ID that is contained in the received authentication request information in Step 44. The search method is the same as the method described using FIG. 3(a) and FIG. 3(b) in the first embodiment.

Based on the tag reader identification information that is contained in the authentication request information, the distance between the location in which shared terminal 500 is installed and the location in which tag reader 510-1 is installed is acquired. In other words, the distance between remote-control terminal 520 and shared terminal 500 is obtained.

Upon obtaining the distance between remote-control terminal 520 and shared terminal 500, a search is performed for the services that are offered from the operation information shown in FIG. 7 using the obtained distance as an execution condition in Step 45.

When service control unit 505 determines that remote-control terminal 520 that is held by the presenter, who is close to shared terminal 500, satisfies “[20000001] [≦2.0]” of execution condition 700, URL information for connecting to the use screen for use by the presenter that corresponds to “0001” of service detail ID 702 is transmitted to remote-control terminal 520 in Step 46.

In this case, the use screen for use by the presenter is a screen that allows manipulations such as marking or moving between pages on the screen that is displayed on screen display unit 503 of shared terminal 500.

The e-mail address of remote-control terminal 520 that is contained in the authentication request information may also be used as the transmission destination, or other information may be used if the information allows identification of remote-control terminal 520.

When the URL information for connecting to the use screen that is intended for use by the presenter that has been transmitted from shared terminal 500 is received in remote-control terminal 520 in Step 47, the received URL information for connecting to the use screen that is intended for use by the presenter is displayed on screen display unit 523 in Step 48.

When the presenter uses input unit 521 to connect to the URL shown on screen display unit 523, the use screen for use by the presenter that is stored in the URL is obtained and displayed on screen display unit 523 in Step 49. The displayed use screen for the presenter is then manipulated by using input unit 521 in Step 50.

On the other hand, when an observer who is participating in the conference holds his or her own remote-control terminal 520 and is seated at a location of the conference room that is separated from shared terminal 500, the tag reader among tag readers 510-2-510-n that has been installed close to remote-control terminal 520 reads the information that is written in IC tag 525 of remote-control terminal 520. It is then determined at shared terminal 500 that remote-control terminal 520 satisfies “[20000001] [>2.0]” of observer execution conditions 700, and URL information that enables making a connection to a use screen that will be used by observers that corresponds to “0002” of service detail ID 702 is transmitted to remote-control terminal 520 in Step 51.

The use screen for use by observers is a screen that only allows viewing of the screen that is displayed on screen display unit 503 of shared terminal 500.

When the URL information for connecting to the use screen for use by observers that is transmitted from shared terminal 500 is received in remote-control terminal 520 in Step 52, the received URL information for connecting to the use screen for use by observers is displayed on screen display unit 523 in Step 53.

When the observer uses input unit 521 to connect to the URL displayed on screen display unit 523, the use screen for use by observers that is stored at that URL is obtained and displayed on screen display unit 523 in Step 54.

A limit may be placed on the number of remote-control terminals 520 that can realize remote control of shared terminal 500.

The time interval during which shared terminal 500 is remote-controlled by remote-control terminal 520 may be stored in shared terminal 500. In other words, the time interval from the authentication of remote-control terminal 520 until operation of the remote control ends may be stored in shared terminal 500.

In the above-described second embodiment, a plurality of tag readers 510-1-510-n are installed in a conference room, and the information that is written to IC tags 525 of remote-control terminals 520 is read by tag readers 510-1-510-n that are installed at locations that are closest to remote-control terminals 520. In this way, use screens that are appropriate to each user who is holding remote-control terminal 520 can be displayed to provide different use modes. In other words, the mere movement of a user that is holding remote-control terminal 520 enables automatic switching of the provided use screens. For example, when user A who is an observer approaches shared terminal 500 to ask a question regarding the conference materials, tag reader 510-1 that is installed in the vicinity of shared terminal 500 detects remote-control terminal 520 that is held by user A. On the other hand, when user B who is the presenter moves away from shared terminal 500, another of tag readers 510-2-510-n detects remote-control terminal 520 that belongs to user B. The operation information is set such that the use screen for the presenter is offered to users at locations close to shared terminal 500, whereby remote-control terminal 520 held by user B automatically switches to the use screen for observers, or remote-control terminal 520 held by user A automatically switches to the use screen for the presenter.

### Third Embodiment

As the third embodiment, an example is described in which a person seeking advice uses audiovisual equipment, which is the shared terminal, to have a remote consultation with a counselor.

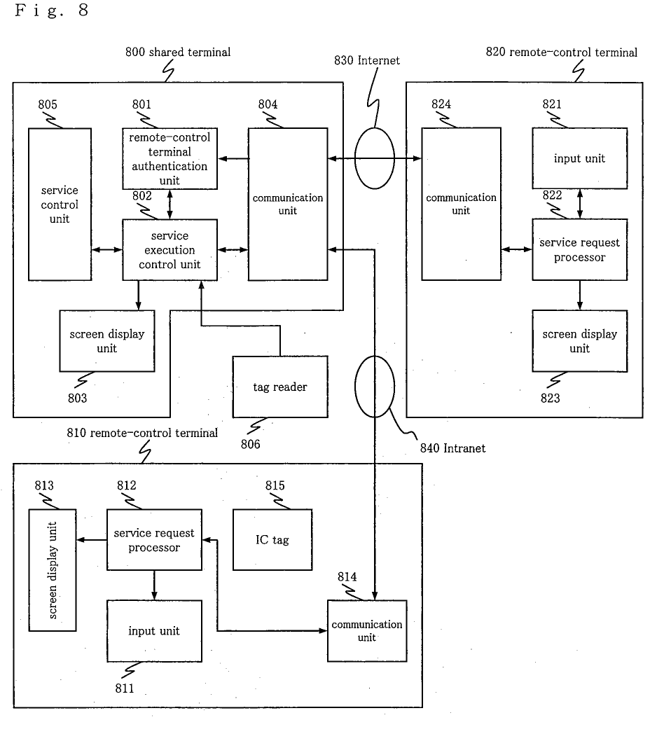

Referring to FIG. 8, the third embodiment of a remote control system is shown that is composed of: shared terminal 800, remote-control terminals 810 and 820, and tag reader 806. Remote-control terminal 820 is connected to shared terminal 800 by way of Internet 830. Remote-control terminal 810 is connected to shared terminal 800 by way of intranet 840. Tag reader 806 is connected to shared terminal 800 by a PC connection cable and reads information that have been written in IC tags. Shared terminal 800 is further composed of: remote-control terminal authentication unit 801, service execution control unit 802, screen display unit 803, communication unit 804, and service control unit 805. Remote-control terminal authentication unit 801 authenticates remote-control terminals 810 and 820. Service control unit 805 controls the services that are supplied to remote-control terminals 810 and 820. Service execution control unit 802 controls the execution of services according to remote-control terminals 810 and 820. Screen display unit 803 displays the state of executed services on a screen. Communication unit 804 communicates with remote-control terminal 820 by way of Internet 830 and communicates with remote-control terminal 810 by way of intranet 840. Remote-control terminal 810 is composed of: input unit 811, service request processor 812, screen display unit 813, communication unit 814, and IC tag 815. Input unit 811 receives as input the content by which the user who is holding remote-control terminal 810 manipulates remote-control terminal 810. Service request processor 812 issues requests for service to shared terminal 800 and accepts the results of these requests. Screen display unit 813 displays the results that have been accepted by service request processor 812. Communication unit 814 communicates with shared terminal 800 by way of intranet 840. IC tag 815 is an IC tag for application in a wireless network in which the authentication request information of remote-control terminal 810 has been written in advance as IC tag information. Remote-control terminal 820 is composed of: input unit 821, service request processor 822, screen display unit 823, and communication unit 824. Input unit 821 receives as input content by which the user who is holding remote-control terminal 820 manipulates remote-control terminal 820. Service request processor 822 issues requests for services to shared terminal 800 and accepts the results of these requests. Screen display unit 823 displays the results that have been accepted by service request processor 822. Communication unit 824 communicates with shared terminal 800 by way of Internet 830. The details of the authentication request information will be explained later.

It is assumed that shared terminal 800, tag reader 806, and remote-control terminal 810 are installed in the audiovisual classroom of a school or preschool. Remote-control terminal 820 may be a portable telephone that is held by, for example, a counselor who is being consulted. Screen display unit 803 may be connected by a display cable to shared terminal 800. In addition, a passive non-contact RFID (radio IC tag) is used as IC tag 815. Remote-control terminal authentication unit 801 records user information that includes the user IDs of users who can effect remote control of shared terminal 800 on a recording medium such as a disk (not shown) or memory (not shown) provided in shared terminal 800. Service control unit 805 records information of services that shared terminal 800 can offer and further, records the role of each terminal that operates in the system, service content, and authority information for manipulating shared terminal 800 in association with each other as operation information on a recording medium such as a disk (not shown) or memory (not shown) that is provided in shared terminal 800. Input units 811 and 821 may be the physical buttons for manipulation that are provided on remote-control terminals 810 and 820, or may be virtual buttons displayed on screen display units 813 and 823, respectively. Screen display units 813 and 823 are compact displays equipped on remote-control terminals 810 and 820, respectively. Radio access points (not shown) are interposed in Internet 830 and intranet 840, and transmission and reception of data between remote-control terminals 810 and 820 and shared terminal 800 passes by way of these access points. It is further assumed that each of the programs and databases that operate in shared terminal 800 and remote-control terminals 810 and 820 are stored on hard disks (not shown) as a recording medium that are physically provided in each of these terminals and are each transferred as necessary to memories (not shown) and executed by CPUs (not shown) that are provided in each of these terminals.

Each of the constituent elements of shared terminal 800 described above operates substantially identically to the constituent elements of shared terminal 100 in the first embodiment of the present invention. The point of difference in the operation between this embodiment and shared terminal 100 in the first embodiment is the selection of the use content of services based on the “connection route” of the terminal that effects remote control without using with “code information.”

Explanation next regards the remote control method in the remote control system that is configured as described above.

When the person seeking advice who is holding remote-control terminal 810 shown in FIG. 8 holds IC tag 815 up to tag reader 806, the authentication request information of remote-control terminal 810 that has been written in advance in IC tag 815 is read by tag reader 806. The authentication request information that has been read is then transmitted from tag reader 806 to shared terminal 800.

On the other hand, shared address information for accessing shared terminal 800 is stored in advance in remote-control terminal 820, and based on this shared address information, remote-control terminal 820 accesses shared terminal 800. Address information (assumed to be an address that can be used temporarily that contains, for example, a one-time password) that is issued and transmitted in real time in shared terminal 800 is then received in remote-control terminal 820, whereupon authentication request information is transmitted from remote-control terminal 820 to this address by way of Internet 830.

The authentication request information includes at least the verification information of remote-control terminals 810 and 820. The verification information is data generated in remote-control terminal authentication unit 801 that includes user IDs for identifying remote-control terminals 810 and 820. The verification information is obtained in advance in remote-control terminal 810 and 820. The authentication request information further includes address information such as the e-mail addresses of remote-control terminals 810 and 820. The verification information may be information generated by selecting another means of shared terminal 800, or may be information issued by another device that issues verification information.

The authentication request information transmitted from remote-control terminal 810 or remote-control terminal 820 is received in service execution control unit 802 in Step 61, whereupon an authentication process is carried out in remote-control terminal authentication unit 801 for the received authentication request information in Step 62.

Connection route information regarding the route by which the authentication request information was received in service execution control unit 802 is added to the information of the authentication process results and is transmitted to service control unit 805. This connection route information is data for identifying whether the authentication request information was transmitted from tag reader 906 or transmitted by way of Internet 830. In service control unit 805, an item that is set for the connection route is provided in place of execution conditions 700 shown in FIG. 7 and the connection route information and service use content are stored in association with each other. In this case, an identifier as the device, i.e., tag reader 806 or communication unit 804, or the network address of the transmission source may be used as the connection route that is set in place of execution conditions 700 shown in FIG. 7.

In service control unit 805, the route of reception is next determined based on the connection route information and a search is performed of the use content according to this connection route information in Step 63.

When it is determined that the reception route is tag reader 806, use content for consultation is searched in service control unit 805 and a screen for consultation is transmitted from service control unit 805 to remote-control terminal 810 by way of communication unit 804 and intranet 840 in Step 64.

On the other hand, if it is determined that the reception route is by way of Internet 830, a search is performed for use content for response in service control unit 805 and a screen for response, is a response screen, transmitted from service control unit 805 to remote-control terminal 820 by way of communication unit 804 and Internet 830 in Step 65.

The consultation screen is a screen to allow consultation about information, and the response screen is a screen that allows the user to regard to information that was under consultation.

If the audiovisual equipment of the present embodiment is installed in a school or preschool, a consultation regarding guidance methods can be held between a counselor and the teacher of a child who is exhibiting problem behavior. By using the Internet (a public network that includes “hot spots” on streets), a counselor who is in charge of a case can respond to inquiries from the teacher even when the counselor is in the hospital or between house calls. The teacher and the counselor are holding remote-control terminals 810 that can realize remote control of the audiovisual equipment in the school, and the teacher can manipulate the audiovisual equipment while viewing the screen of screen display unit 803 of shared terminal 800. As a result, a simple manipulation interface is provided on remote-control terminal 810 that belongs to the teacher, and screen data displayed on shared terminal 800 and a manipulation interface are offered on remote-control terminal 820 that belongs to the counselor. This suggests that the amount of information that can be held by users who are implementing remote control differs depending on whether the users who are using shared terminal 800 are at shared terminal 800 or away from shared terminal 800. It is therefore effective to switch the service content to include necessary information according to the user's state of use.

As explained hereinabove, the examples of a seminar, a TV conference, and a remote consultation have been described as embodiments of the present invention, but the present invention can be applied to other uses. When used for an event in which participants actually attend, those who preside over the event and the attendees who have gathered at the event site have portable telephones as the remote-control terminals and proceed with a game while viewing a screen that is located over the stage. A manipulation interface that can control the proceedings is provided on the portable telephone of persons presiding over the event who are on the stage, and a manipulation interface for participating in the game is provided on the portable telephones, which are the remote-control terminals, of attendees who are at the event site. Persons presiding over the event can confer participation rights to attendees who have indicated an interest in participating in the game. Alternatively, as in a remote consultation, the function by which both parties can manipulate the screen of a shared terminal even when the communication partners are not at the same site can be used for urgent responses in manufacturing situations or for remote business negotiations regarding financial matters.

In the present invention, in addition to using dedicated hardware to realize the processes in each of the constituent elements of shared terminals 100, 500, and 800, information-providing terminal 110, remote-control terminals 120, 520, 810, and 820, and tag readers 510-1-510-n, programs for realizing these functions may also be recorded on a recording medium that can be read in each of shared terminals 100, 500, and 800, information-providing terminal 110, remote-control terminals 120, 520, 810, and 820, and tag readers 510-1-510-n, and the programs that have been recorded in these recording media may be read to each of shared terminals 100, 500, and 800, information-providing terminal 110, remote-control terminals 120, 520, 810, and 820, and tag readers 510-1-510-n and then executed. The recording media that can be read by each of shared terminals 100, 500, and 800, information-providing terminal 110, remote-control terminals 120, 520, 810, and 820, and tag readers 510-1-510-n may be recording media that can be removed such as a floppy disk, a magnet-optical disk, a DVD, or a CD; or may be an HDD that is built into shared terminals 100, 500, and 800, information-providing terminal 110, remote-control terminals 120, 520, 810, and 820, and tag readers 510-1-510-n. The programs that are recorded in these recording media are read into each constituent element, and processes identical to those described hereinabove are then carried out by each constituent element.

While a preferred embodiment of the present invention has been described in specific terms, such description is for illustrative purpose only, and it is to be understood that changes and variations may be made without departing from the spirit or scope of the following claims.

What is claimed is:

1. A remote control system comprising: a shared terminal that users can use in common, information-providing terminal connected to said shared terminal by way of a wireless network, and remote-control terminals belonging to users and connected to said shared terminal and to said information-providing terminal by way of a wireless network; wherein:
said shared terminal: includes a database in which authentication request information that contains information that can identify said remote-control terminals and use content of said remote-control terminals are stored in advance in association with each other; receives authentication request information transmitted from said remote-control terminals; searches use content of said remote-control terminals from said database based on the received authentication request information; and transmits a use screen to said remote-control terminal for realizing remote control of said shared terminal based on the use content;
said information-providing terminal displays code information containing information that can identify the location at which the information-providing terminal is installed; and
said remote-control terminals: read code information that is displayed on said information-providing terminal; transmit to said shared terminal said authentication request information that contains the content of the code information; receive and display use screens that have been transmitted from said shared terminal; and effect remote control of said shared terminal in accordance with the use screens that are displayed.

2. The remote control system according to claim 1, wherein:
said shared terminal displays code information that contains information that can identify the location at which said shared terminal is installed; and
said remote-control terminals read one item of code information displayed on said shared terminal and code information displayed on said information-providing terminal.

3. The remote control system according to claim 1, wherein said shared terminal limits the number of said remote-control terminals that can realize remote control of the shared terminal.

4. The remote control system according to claim 1, wherein said shared terminal stores the time interval during which said shared terminal was remote controlled by said remote-control terminals.

5. A remote control system comprising remote-control terminals, readers for reading identification information of said remote-control terminals, and a shared terminal that is connected to said remote-control terminals and said readers by way of a wireless network; wherein:
said readers generate authentication request information from said identification information of said remote-control terminals that has been read and from identification information of said readers and transmit the authentication request information to said shared terminal;
said shared terminal: includes a database in which said authentication request information and use content of said remote-control terminals are stored in association with each other in advance, receives authentication request information transmitted from said readers, searches said database for use content of said remote-control terminals based on said authentication request information, and transmits to said remote-control terminals use screens for effecting remote control of said shared terminal based on said use content; and
said remote-control terminals receive and display use screens that are transmitted from said shared terminal, and effect remote control of said shared terminal in accordance with these displayed use screens.

6. The remote control system according to claim 5, wherein:
said remote-control terminals include IC tags in which said identification information of said remote-control terminals has been written in advance; and
said readers are tag readers for reading identification information that is written in said IC tags.

7. The remote control system according to claim 5, wherein said shared terminal:
includes a database in which said authentication request information, the distance between the location of installation of said readers and the location of installation of said shared terminal, and the use content of said remote-control terminals have been stored in association with each other in advance;
obtains the distance between the location of installation of said readers and the location of said shared terminal based on identification information of said readers that is contained in said authentication request information; and
searches said database for the use content of said remote-control terminals based on this distance and said authentication request information.

8. The remote control system according to claim 5, wherein said shared terminal controls the number of said remote-control terminals that effect remote control of said shared terminal.

9. The remote control system according to claim 5, wherein said shared terminal stores the time interval during which said shared terminal is remote controlled by said remote-control terminals.

10. A remote control system comprising a shared terminal that is used in common by users, and remote-control terminals that are connected to said shared terminal by way of a wireless network; wherein:
said remote-control terminals transmit to said shared terminal authentication request information that contains information that can identify said remote-control terminals, receive and display use screens that are transmitted from said shared terminal, and effect remote control of said shared terminal in accordance with the displayed use screens; and
said shared terminal: includes a database in which said authentication request information, connection route information indicating the route by which said authentication request information was transmitted, and use content of said remote-control terminals are stored in association with each other in advance; searches said database for use content of said remote-control terminals based on said authentication request information and connection route information that indicate the route by which said authentication request information was transmitted; and transmits to said remote-control terminals use screens for effecting remote control of said shared terminal based on the use content.

11. A method in a remote control system that comprises a shared terminal having a database, an information-providing terminal connected to said shared terminal by way of a wireless network, and remote-control terminals that belong to users and that are connected to said shared terminal and to said information-providing terminal by way of a wireless network; said method comprising steps of:
in said information-providing terminal, displaying code information containing information that can identify the location of the information-providing terminal;
in said remote-control terminals, reading code information displayed on said information-providing terminal;
transmitting, to said shared terminals from said remote-control terminal, authentication request information that contains said code information that has been read and information that can identify the remote-control terminals;
in said shared terminal, receiving said authentication request information and, based on the received authentication request information, searching said database for use content of said remote-control terminals;
based on said use content, transmitting to said remote-control terminals use screens for effecting remote control of said shared terminal; and
receiving and displaying use screens transmitted from said shared terminal in said remote-control terminals.

12. The method according to claim 11, further comprising steps of:
in said shared terminal, displaying code information containing information that can identify the location of said shared terminal; and
in said remote-control terminals, reading one item of code information displayed on said shared terminal and one item of code information displayed on said information-providing terminal.

13. The method according to claim 11, comprising a step of, in said shared terminal, limiting the number of said remote-control terminals that effect remote control of said shared terminal.

14. The method according to claim 11, comprising a step of, in said shared terminal, storing the time interval during which said shared terminal is remote controlled by said remote-control terminals.

15. A method in a remote control system that comprises remote-control terminals, readers for reading identification information of the remote-control terminals, and a shared terminal that is connected to said remote-control terminals and to said readers by way of a wireless network and that includes a database; said method comprising steps of:
in said readers, generating authentication request information from said identification information of said remote-control terminals that has been read and from identification information of said readers;
transmitting the authentication request information to said shared terminal;
in said shared terminal, receiving the authentication request information that has been transmitted from said readers, and based on said authentication request information, searching said database for use content of said remote-control terminals;
transmitting use screens to said remote-control terminals for effecting remote control of said shared terminal based on said use content from said shared terminal; and
receiving and displaying in said remote-control terminals use screens that have been transmitted from said shared terminal.

16. The method according to claim 15, further comprising steps of:
in said shared terminal, obtaining the distance between the location of readers and the location of said shared terminal based on identification information of said readers that is contained in said authentication request information; and
based on the distance and said authentication request information, searching said database for use content of said remote-control terminals.

17. The method according to claim 15, further comprising a step of, in said shared terminal, limiting the number of said remote-control terminals that can effect remote control of said shared terminal.

18. The method according to claim 15, further comprising a step of, in said shared terminal, storing the time interval in which said shared terminal is remote controlled by said remote-control terminals.

19. A method in a remote control system that comprises a shared terminal having a database and remote-control terminals that are connected to said shared terminal by way of a wireless network; said method comprising steps of:
transmitting to said shared terminal from said remote-control terminals authentication request information that contains information that can identify the remote-control terminals;
in said shared terminal, searching said database for use content of said remote-control terminals based on said authentication request information and connection route information that indicate the route by which said authentication request information was transmitted;
transmitting to said remote-control terminals use screens for effecting remote control of said shared terminal based on the use content; and
receiving and displaying on said remote-control terminals use screens that have been transmitted from said shared terminal.

20. A recording medium for recording a computer program causing a computer to execute:
a process for, based on authentication request information that has been received in said computer, searching a database for use content for effecting remote control of said computer; and
a process for transmitting use screens that accord with the use content to remote-control terminals for effecting remote control of said computer.
